(19) United States
(12) Patent Application Publication
(10) Pub. No.: US 2002/0124938 A1
(43) Pub. Date: Sep. 12, 2002

(54) Apparatus and method for producing non- or lightly-embossed panels

(76) Inventors: Peter J. Henrich, White Bear Lake, MN (US); Jeffrey D. Smischney, Rush City, MN (US)

Correspondence Address: Robert D. Fish, Fish & Associates, LLP, 1440 N. Harbor Blvd., Suite 706, Fullerton, CA, 92835, US

(21) Appl. No.: 09/752,411

(22) Filed: Dec. 28, 2000

(51) Int. Cl. B32B 31/00

(52) U.S. Cl. 156/189; 156/64; 709/200

(57) ABSTRACT

Compositions and methods are provided whereby a separator sheet is produced that comprises a) an alloy substrate layer having a top surface and a bottom surface, b) a first metal layer, c) a second metal layer, and d) an intermediate metallic material that couples the first metal layer to the top surface of the substrate layer and that couples the second metal layer to the bottom surface of the substrate layer. The separator sheet can be incorporated into the production of a layered material. The layered material is then further incorporated into an electronic component. The intermediate material and the alloy layers is removed from the layered material before the material is incorporated into an electronic component. Further, the first and second metal layers of the separator sheet are not removed from the layered material, and they function as laminates for the layered materials that are incorporated in the electronic components. The separator sheets also provide a stable surface for the laminates so that the laminates can be layered onto the layered materials with minimal embossing defects in the laminate. Electronic components contemplated herein may be produced by a) obtaining a source data set from a customer; b) applying an algorithm to the source data set to produce a results data set comprising at least one subset of results data for a layer of laminating material; c) using the results data set to produce a set of requirements for the composition of a separator sheet, d) further using the results data set to form a set of operating conditions for an arrangement of production machinery; and d) operating the machinery according to the operating conditions to produce the electronic component.

### Field of The Invention

The field of the invention is electronic components.

### Background of The Invention

Electronic components are used in ever increasing numbers of consumer and commercial electronic products. Examples of some of these consumer and commercial products are televisions, computers, cell phones, pagers, a palm-type organizer, portable radios, car stereos, or remote controls. As the demand for these consumer and commercial electronics increases, there is also a demand for those same products to become smaller and more portable for the consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging.

When electronic components are reduced in size or scaled down, any defects that are present in the larger components are going to be exaggerated in the scaled down components. Thus, the defects that are present or could be present in the larger component should be identified and corrected, if possible, before the component is scaled down for the smaller electronic products.

In order to identify and correct defects in electronic components, the components, the materials used and the manufacturing processes for making those components should be broken down and analyzed. Electronic components are composed, in some cases, of layers of materials, such as metals, polymers, metal alloys, inorganic materials or organometallic materials. The layers of materials are often thin (on the order of less than a millimeter in thickness) and delicate.

Thin layers, because of their structure, are vulnerable to many defects, including tears, indentations, image transfer problems, lack of “flatness”, or “bunching” of the materials comprising the thin layer during the process of building up the layered materials and lamination of the layered materials. These defects in thin layers can be considered in the class of defects known as embossing defects. Embossing defects can be devastating to a lamination layer and a layered electronic component if one or more of the layers in the component contains these defects.

Copper has traditionally been used as a lamination material for layered materials; however, it can be difficult to work with in thin layers because it's relatively soft and tears easily. In order to ease incorporation of the copper layers onto components, a separator sheet is coupled with the copper layer to provide support for the copper. Stainless steel and aluminum have been used as separator sheets in applying copper lamination and thin layers, but both steel and aluminum used independently lead to problems in the copper layers. Using steel alone results in panels and layers that are less susceptible to embossing, but are more susceptible to poor surface quality. Using aluminum with the copper layers results in panels that are less susceptible to poor surface quality, but are more susceptible to embossing defects.

Thus, there is a continuing need to a) design and produce layered materials that meet customer specifications while minimizing embossing, and b) incorporate those layered materials into electronic components and products according to customer requirements and specifications.

### Summary of the Invention

Compositions and methods are provided whereby a separator sheet that can minimize or eliminate embossing defects is produced that comprises a) an alloy substrate layer having a top surface and a bottom surface, b) a first metal layer, c) a second metal layer, and d) an intermediate metallic material that couples the first metal layer to the top surface of the substrate layer and that couples the second metal layer to the bottom surface of the substrate layer.

In a first aspect of a preferred embodiment, the separator sheet is incorporated into the production of a layered material. The layered material is then further incorporated into an electronic component.

In another aspect of a preferred embodiment, the intermediate material and the alloy layers are removed from the layered material before the material is incorporated into an electronic component. Further, the first and second metal layers of the separator sheet are not removed from the layered material, and they function as laminates for the layered materials that are incorporated in the electronic components.

In yet another aspect of a preferred embodiment, the separator sheets contemplated herein provide a stable surface for the laminates so that the laminates can be layered onto the layered materials with minimal embossing defects in the laminate.

Electronic components contemplated herein may be produced by a) obtaining a source data set from a customer; b) applying an algorithm to the source data set to produce a results data set comprising at least one subset of results data for a layer of laminating material; c) using the results data set to produce a set of requirements for the composition of a separator sheet, d) further using the results data set to form a set of operating conditions for an arrangement of production machinery; and d) operating the machinery according to the operating conditions to produce the electronic component.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic diagram of a preferred embodiment.

FIG. 2 is a flowchart showing a preferred embodiment of the method of the invention contemplated.

FIG. 3 is a flowchart showing a preferred embodiment of the method of the invention contemplated.

FIG. 4 is a schematic diagram of the physical relationship of the components in a preferred laminated panel.

FIG. 5 is a schematic diagram of the physical representation of part of the lay up within an apparatus at lamination.

FIG. 6 is a schematic diagram showing a physical representation of the entire lay up within an apparatus at lamination.

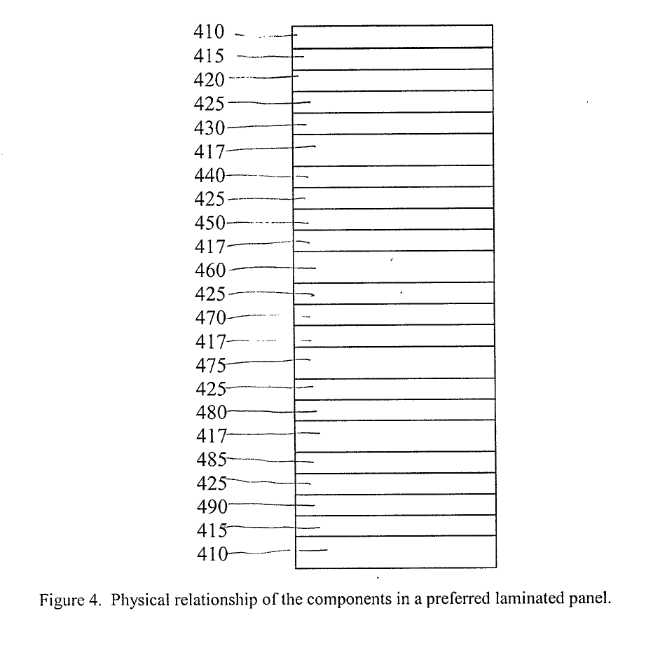

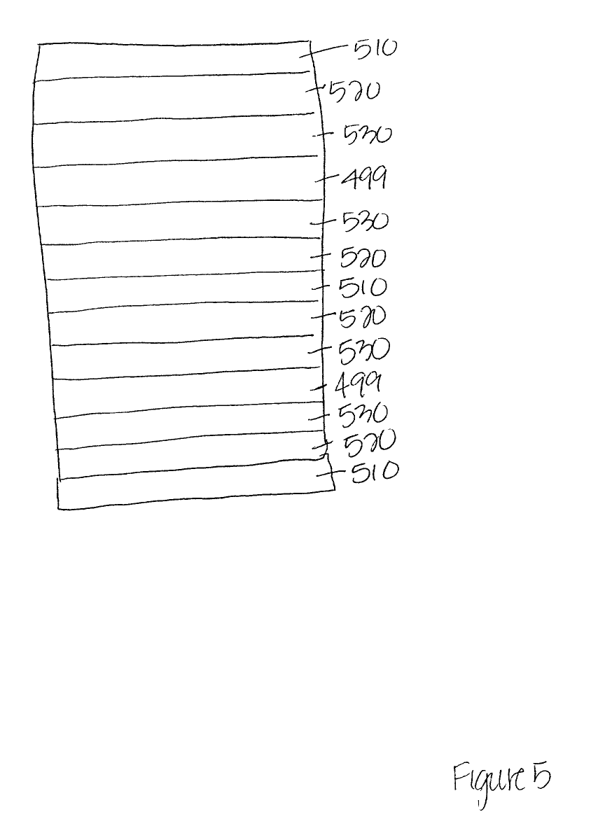

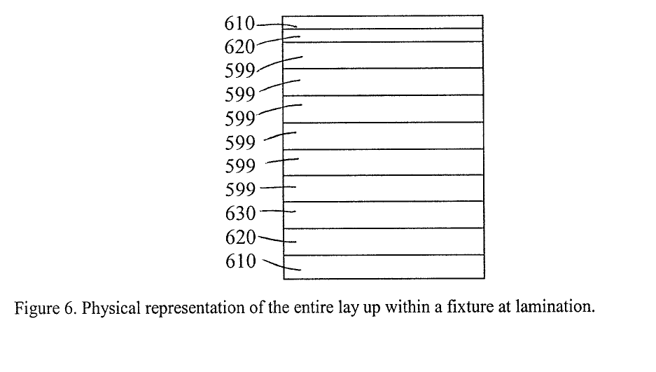

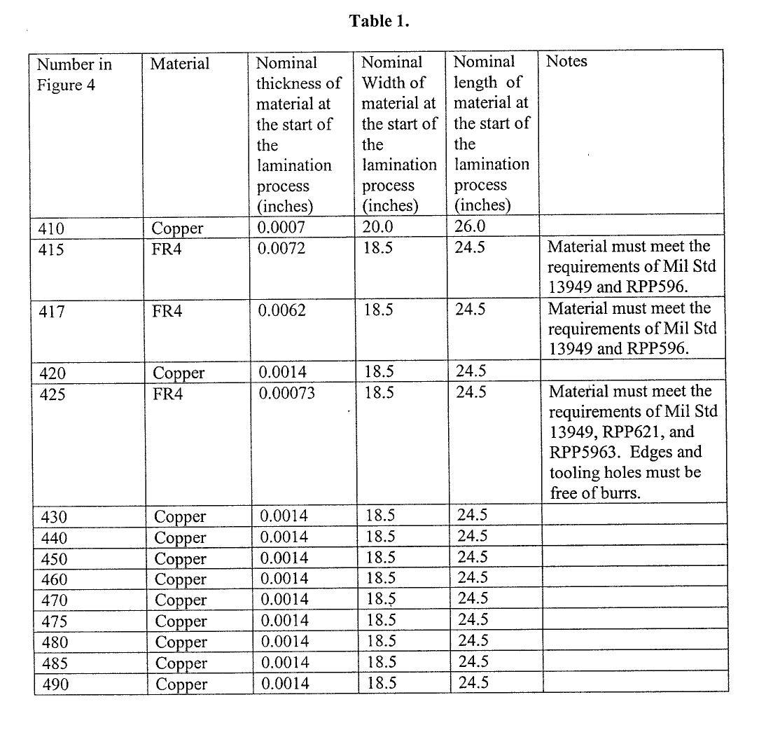

Table 1 shows the components contemplated in FIG. 4 and some of their characteristics.

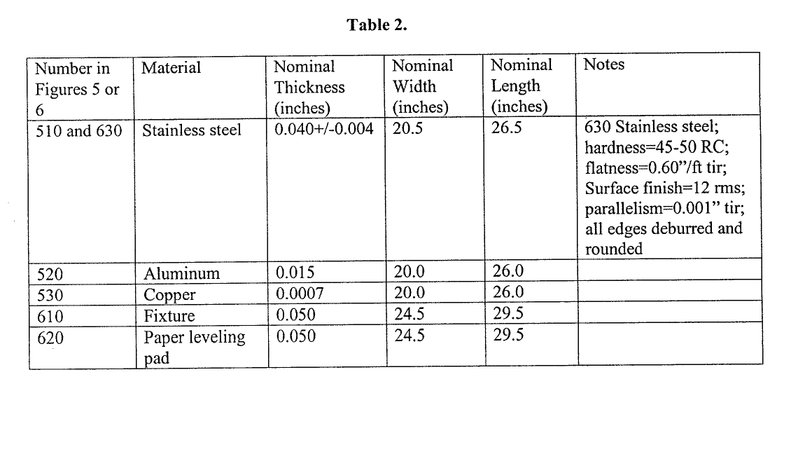

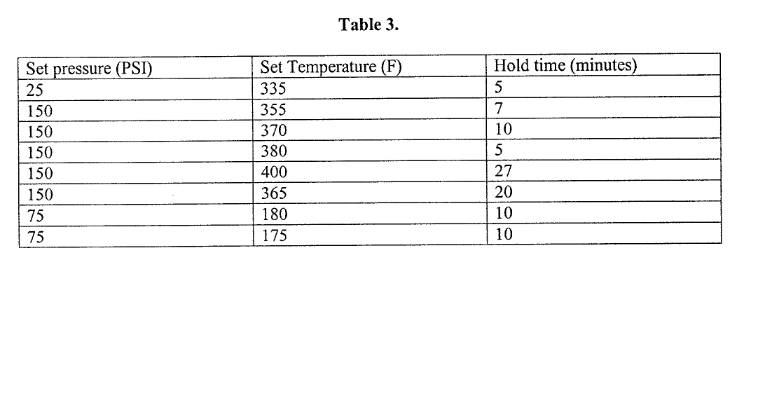

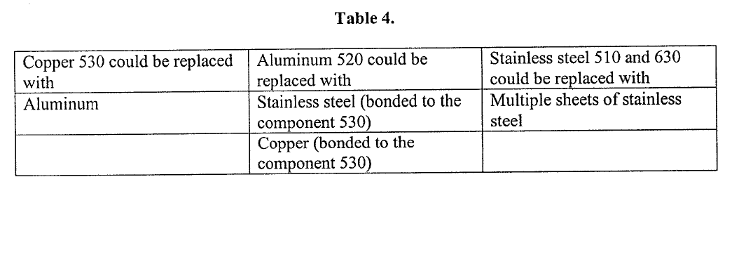

Table 2 shows the components contemplated in FIGS. 5 and 6 and some of their characteristics.

Table 3 shows a preferred lamination press cycle.

Table 4 shows some preferred alternate materials.

### DETAILED DESCRIPTION

Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up mock-up. A prototype may or may not contain all of the actual components intended in a finished product, and a prototype may have some components that are constructed out of composite material in order to negate their initial effects on other components while being initially tested.

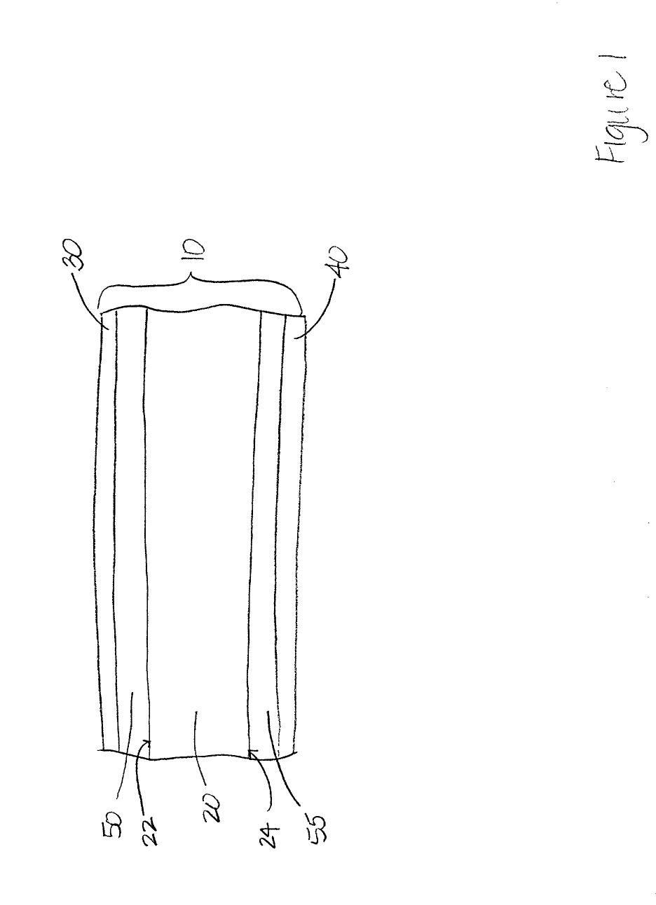

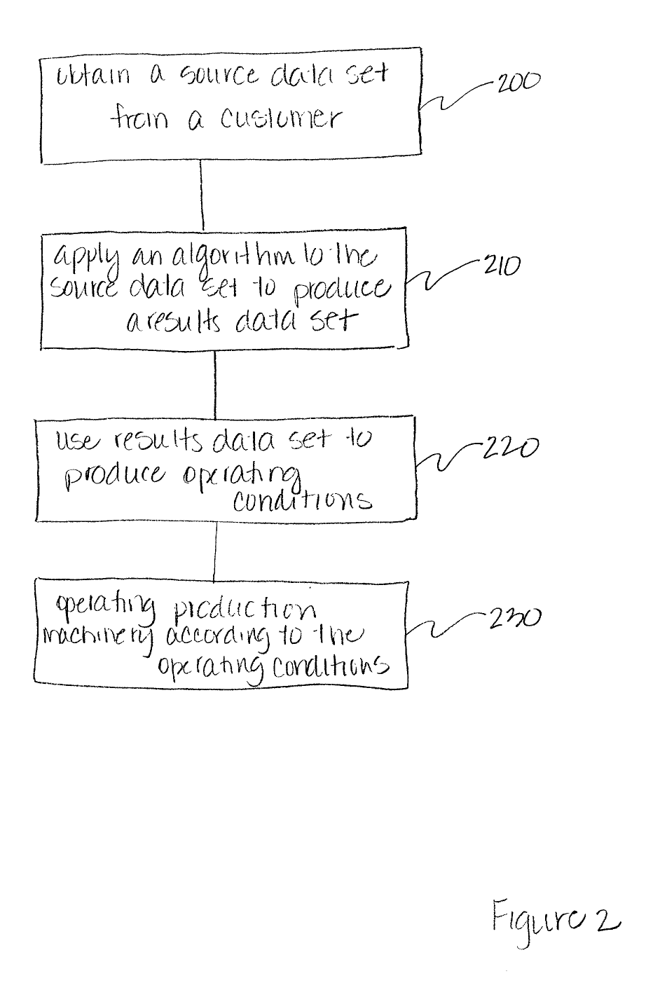

In FIG. 1, a separator sheet 10 that can minimize or eliminate embossing defects is shown that comprises a) an alloy substrate layer 20 having a top surface 22 and a bottom surface 24, b) a first metal layer 30, c) a second metal layer 40, and d) a first intermediate metallic material 50 that couples the first metal layer 30 to the top surface 22 of the substrate layer 20 and a second intermediate metallic material 55 that couples the second metal layer 40 to the bottom surface 24 of the substrate layer 20.

The alloy substrate layer 20 should have the following desirable properties for the subject matter contemplated herein: a) a substantial hardness, wherein “hardness” means the resistance of a material to deformation of an indenter of specific size and shape under a known load; b) a low incidence of corrosion; c) composed of materials that are readily available in the electronics industry; d) environmentally “friendly ” to work with during, to remove out of, and to dispose from the process. As used herein, the phrase “substantial hardness” generally means that the compound or material is not easily penetrated, does not easily yield to pressure, and has a measured hardness (measured on a known scale, such as the ASTM hardness scale) that would classify the compound or material in the top 49% on a scale of materials ranging from hard to soft.

The alloy substrate layer 20, as a whole, should support the intermediate metallic layer 50 and the first or second metal layers 20 and 30 before lamination of the layered material. The alloy substrate layer 20 should also facilitate lamination of the layered material by providing a sheet that's easy to work with and stable under a variety of manufacturing environments and processes.

Keeping in mind the specific application and also desirable characteristics and properties, the alloy substrate layer 20 may comprise any substantially solid alloy material. Alloy materials are any solid mixture of two or more metals, or of one or more metals with nonmetallic elements, as in carbon steels. If it happens that a substrate material comprising gold is the most economic or efficient, then the substrate material must include another element or elements that will create a harder alloy material than pure gold. It is more preferred that the alloy substrate layer 20 comprises a material that is steel-based. As used herein, the term “steel-based” means a material that comprises, among other things, iron and a small percentage of carbon (0.02%-1.5%). Steel-based compounds may also comprise other elements, such as chromium, nickel, tungsten, molybdenum, manganese, vanadium, cobalt and zirconium, depending on the qualities desired for the material. It is contemplated that steel-based materials or compounds could also comprise stainless steel, a specific group of steel-based compounds. Stainless steel is alloy steel containing high percentages of chromium, from less than 10% to more than 25%.

The alloy substrate layer 20 comprises a top surface 22 and a bottom surface 24. The top surface 22 and bottom surface 24 are contemplated to be fairly smooth and free of defects. Ideally, the top surface 22 and bottom surface 24 should not contribute to the formation of embossing defects. The top surface 22 and bottom surface 24 are generally intended to be a place where the intermediate metallic layer 50 or 55 and the substrate layer 20 are coupled.

The first metal layer 30 should comprise a material that is relatively soft and can function as a laminate for layered materials used in electronic components. Suitable metals that may be used as a first metal layer 30 includes titanium, cobalt, copper, nickel, zinc, vanadium, chromium, platinum, gold, silver, tungsten, and molybdenum. Preferred metals include titanium, copper, nickel, platinum, gold, silver and tungsten. More preferred metals include titanium, copper and nickel. The term “metal” also includes alloys, metal/metal composites, metal ceramic composites, metal polymer composites, as well as other metal composites, as long as the metal conforms to the desirable properties for the metal layer 30.

The second metal layer 40 is similar to the first metal layer 30, in that the second metal layer should be soft and should be able to function as a laminate or as a laminating material. The second metal layer 40 may also comprise metals that were previously contemplated for the first metal layer 30. Although the first and second metal layers may comprise similar materials, each layer does not have to be simultaneously identical to the other layer. For example, the first metal layer 30 may be copper and the second metal layer 40 may be nickel.

The first and second intermediate metallic materials 50 and 55 are contemplated to have the following desirable characteristics: a) the material has metallic properties, and b) the material may be removed from the first and second metal layers and disposed of in an environmentally friendly manner.

The first intermediate metallic material 50 and the second intermediate metallic material 55 should comprise a material that can be easily removed from both the first or second metal layers and the substrate layer when producing electronic components. Suitable materials comprise any material with metallic properties, including alloys, metal/metal composites, metal ceramic composites, metal polymer composites, as well as other metal composites, as long as the metal conforms to the desirable properties for the intermediate metallic layer 50 and 55.

The first metal layer 30 can be coupled to the first intermediate metallic material 50 by any suitable means, including resin, adhesive, weld, and combinations, such as adhesive and weld, or pressure to form a first pair. The second metal layer 40 can also be coupled to the second intermediate metallic material 55 by any suitable means to form a second pair.

The first layer 30 and/or the second metal layer 40 can also be coupled to the intermediate metallic materials 50 and 55 before the intermediate materials 50 and 55 are coupled to the alloy substrate layer 10. For example, sheets of coupled copper (first metal layer 30) and aluminum (intermediate material 50 or 55) are commercially available for use in electronic applications. These materials are coupled before being further coupled with the alloy substrate layer 10. It is also contemplated that the three layers of materials—the metal layer, the metallic layer, and the alloy layer—may enter the process as separate materials and be coupled during the actual process of building the layered separator sheet.

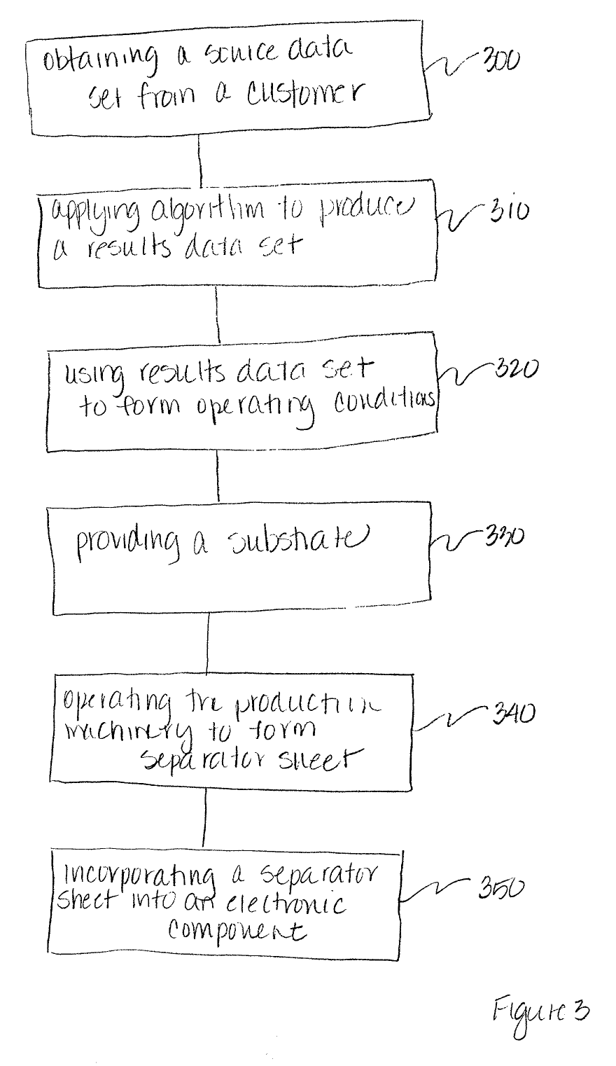

Separator sheets and electronic components contemplated herein may be produced by the vendor by a) obtaining a source data set relating to the components of a layered material and/or a separator sheet from a customer 200; b) applying an algorithm to the source data set to produce a results data set comprising at least one subset of results data for a separator sheet 210; c) using the results data set to form a set of operating conditions for an arrangement of production machinery 220; and d) operating the machinery according to the operating conditions to produce the separator sheet and/or the electronic component 230, as shown in FIG. 2.

The vendor is preferably a company that dedicates a major portion of its business to designing and/or manufacturing electronic components. An example of a contemplated vendor would be Honeywell Advanced Circuits. The term “vendor” should, however, be interpreted broadly to include any person, company, or other entity that interacts with customers as set forth herein. Actions said to be taken by a vendor should be interpreted as including acts of its employees, agents, computer systems, and so forth.

The source data set can be collected or loaded by a vendor from the customer by several means, including on paper, by phone, in person, and through the Internet. Loading of the source data set from the Internet, for example, can be advantageously accomplished using a browser link at the first interactive interface to point the interface to a data file, or by typing data into a plurality of data boxes that are designed to accept and/or store large sets of data or textual information, such as that which is contained within the source data set.

Preferred source data sets contains numerical, textual, or a combination of numerical and textual information about the needs of the customer regarding the design and performance of the desired component or components, including the separator sheets and other layered materials and the foreseeable finished product or prototype that incorporates those components. The customer, for example, may require a copper-laminated layered material that is 95% free of embossing defects. On the other hand, a customer may need a nickel-laminated layered material that is 60-80% free of embossing defects. The customer may also have layering and laminating needs related to other parts of the component or other related components that should be factored in when designing and producing a particular component. For example, the customer may require that the layered material and the lamination in one component be 90% free of embossing defects, but that the other layered components that are also designated for integration in the electronic product be at least 80% free of embossing defects so that those defects don't undermine the original component's performance. Some of the customer design requirements may also be related to overall cost of the final product and available materials at the time of design and manufacture of the components and product. The vendor should try to get as much of this information initially included in the source data set so that the design and production process is cost efficient and timely.

The source data set may comprise information and design specifications, such as chemical composition data, structural information, design and engineering data and/or functional data. In preferred embodiments, the source data set comprises pre-production data, CAD data (Computer Aided Design data) or Gerber data. Gerber data format is a format designed by Gerber Scientific for use with their photoplotters. The industry has accepted Gerber as a universal format because of the vast number of different CAD formats being used today. The printed circuit industry has adopted it as a standard because of the flexible and reliable way in which it can be used for photo plotting printed circuit artworks. Gerber data contains the X and Y coordinates of pad positions and the coordinates for the start and end of traces. These are preceded by codes to tell the photoplotter what it should do with these coordinates. Gerber data is presented in the following formats accepted in the industry: RS274D, RS-274X, BARCO DPF and Fire9000.

Chemical composition data includes any data or textual information that describes the chemical makeup or composition of the separator sheet, the product or components of the product, such as the individual layers, the adhesives, or the curing agents. Examples of chemical composition data are a) chemical composition of the layers of materials in the separator sheet, b) chemical composition information of the layered materials in the component, and c) adhesive or resin composition, if any is present in the layered component.

Chemical composition data is important to the vendor because the chemistry of each layer or the chemical interaction of the layers can directly influence the performance and longevity of the electronic component and ultimately the electronic product. For example, if one of the layers incorporated in the component corrodes easily, and the component is going to be used in a pool heater or in a shower radio, then that layer should be replaced, if possible, by a more non-corrosive material.

Structural information and/or data include any data or textual information that describes the structure of the separator sheet, the product or of the components of the product. Examples of structural information or data are a) size and shape particulars of the product or the components of the product, b) number of chip packaging layers, c) physical layout of components or chemical constituents in the product, d) density of the traces, e) location of the pads, and f) color of the product or the components of the product.

Structural data is important to the vendor because of how a layered material is built up and supported in the electronic component or product. For example, if a substrate for a layered material needs to be flexible for the application, then the materials layered onto the substrate need to be able to flex and “give” with the substrate. Thus, some of the harder materials may not be suitable to the layered component.

Functional data and/or information include any data or textual information that describes the functional properties or characteristics of the separator sheet, the product or components of the product. Examples of functional data are a) impedance value, b) capacitance value, c) noise, d) noise susceptibility, e) moisture susceptibility, f) resistance value, g) voltage value, h) current value, i) electrical testing data, and j) desired dielectric constant or value.

Functional data is important for the vendor to know and take into account in order to maximize the performance of the component and the product. For example, if a metallic composite material offers superior electrical qualities while not being susceptible to moisture —that material could be useful in a layered component, if the chemistry and structural properties of the composite material are also suitable for the application.

Once the vendor receives suitable chemical, structural and functional source data, the vendor applies an algorithm to the source data set to ultimately produce a results data set. Generation of the results data set occurs from the manipulation of a plurality of intermediate data sets that are generated from the source data set.

An intermediate data set is a data set that results from an intended, methodical and predictive mathematical, theoretical, logical, physical or digital manipulation of the information in the source data set. It is contemplated that the application of a mathematical, theoretical, logical, physical or digital manipulation to the information in the source data set can be defined as an application of an “algorithm”. It is further contemplated that the method and systems described in U.S. patent application Ser. No. 09/543628 would be a suitable example of a mathematical algorithm that simulates polymer/polymer or polymer/substrate interfaces and is herein incorporated by reference. It is even further contemplated that the method and systems described in U.S. patent application Ser. No. 09/569441 would be a suitable example of the application of an algorithm to a source data set to produce a results data set, and is herein incorporated by reference.

The intermediate data set may comprise purely numerical information, a mixture of numerical and qualitative information, or purely qualitative information. The phrase “qualitative information” means information that is not numerical and is, in most cases, is in the form of textual information. In preferred embodiments, the intermediate data set comprises a mixture of numerical and qualitative information.

The challenge of producing and working with separator sheets while minimizing or eliminating embossing defects presents problems for the vendor/producer of the electronic component. Mathematical, theoretical or digital manipulation of the information in the source data set and/or intermediate data set or sets may be designed to simulate or identify manufacturing challenges or defects, product challenges or defects and/or design alternatives in general and in working with separator sheets, related layered materials, such that embossing defects are minimized or eliminated altogether.

Manufacturing defects or “challenges” are generally those defects/challenges that result from a problem in the manufacturing process in general and the manufacturing process relating to reducing or eliminating embossing defects and producing/working with separator sheets, while maximizing the surface quality of the external surfaces of the laminated panel. Some of the manufacturing challenges include compiling the substrate layer, the metal layers and the metallic materials; determining proper curing times and temperatures in building the separator sheets; and incorporating the separator sheet into the other layered materials in the electronic component.

Product defects and challenges are generally those defects and challenges physically present in the product itself when incorporating a separator sheet and lamination materials designed to minimize embossing, such as cracks, image transfer, fracturing at interfaces, or faulty connections, while maximizing surface quality of the laminated outer panels or layers.

Design alternatives or modifications are generally characterized as summaries of the problems and design challenges present in the process or the product, or design challenges present when working with separator sheets and the potential solutions to successfully combining separator sheets with the layered materials while minimizing or eliminating embossing defects.

The intermediate data set is analyzed for a set of predetermined markers or “errors”. Predetermined markers or “errors”, in this case, may be any numerical or descriptive term that the vendor recognizes as being an important or significant identification mark present in the intermediate data set after application of the algorithm or set of algorithms. Examples of predetermined markers are a) temperature data which exceeds industry standards, b) resistance, impedance, or current data that does not meet industry minimums or standards, c) hardness of the alloy substrate layer, and d) data that would suggest the likelihood of embossing, cracking, fracturing or complete degradation of any or all of the materials and/or layers in the electronic component.

After the vendor identifies the predetermined markers, the intermediate data set can be categorized, and then ordered based on those predetermined markers, to form the results data set. It is contemplated that the intermediate data set can be ordered by using typical spreadsheet software, such as Microsoft Excel™ or QuattroPro™ and statistical software and software packages, such as Minitab®.

Once the intermediate data set is categorized and ordered, at least part of the results data set can then be left in the original database or transferred into another database, depending on the type of information produced. The term “database”, as used herein, means a large collection of data organized especially for rapid input search and/or retrieval, as by a computer. Contemplated databases can be spreadsheets, such as Excel™ or QuattroPro™, or relational database systems, such as Microsoft Access™, Oracle Server™, or Microsoft SQL Server™. Statistical software and software packages, such as Minitab® may also be included. Databases contemplated herein may also be linked to other databases within or outside of the system defined herein.

The results data set includes information related to design improvement, design errors, and overall design efficiency of the separator sheet or other layered materials in light of the goal of minimizing or eliminating embossing defects. The results data set can be any information that is customized and generated based on the particular design needs of the customer regarding the product or to the particular design specifics of the product. Further, the results data set comprises at least one subset of results data for a layer of lamination incorporated through the use of a separator sheet.

The results data set can be a) used to determine the operating conditions for an arrangement of production machinery and/or b) converted into an electronically accessible format and is displayed to the customer for additional feedback or suggestions.

The information from the results data set is preferably utilized by the vendor to define a set of operating conditions that will, in turn, be used to ultimately configure the production machinery that will assemble both the separator sheet and the electronic component. Likely operating conditions include a) etching method to remove alloy substrate layer, b) method of layering the alloy substrate materials with the metallic materials and the metal layers, c) temperature required to aid in the application of each layer or material to the component, d) level of humidity required when applying each layer or material to the component, and e) curing time for each material or layer.

A related method of producing an electronic component includes a) obtaining a source data set from a customer 300; b) applying an algorithm to the source data set to produce a results data set comprising at least one subset of results data for an electronic component 310; c) using the results data set to form a set of operating conditions for an arrangement of production machinery 320; d) providing a substrate 330; e) operating the production machinery 340 according to the operating instructions in order to couple a first layer to the substrate; couple a separator sheet to the first layer; couple at least one additional layer to the separator sheet; cure the at least one additional layer; and remove at least part of the separator sheet.

If the results data set is to be displayed to the customer, then it can be converted into electronic format by “Web-enabling” the database or collection of databases. The term “Web-enabled” means that the database is accessible through or by the customer performing a set of commands at a Web browser or Web site, such as by accessing predetermined choices from a list box or via query language. The Web browser or Web site can be used to access a public network and/or private network, such as the Internet.

The results data set is preferably displayed or otherwise made available to the customer or made available to the customer within a relatively short period after the source data set is transmitted to the vendor. The results data set may advantageously be made available to the customer within 72 hours of the customer inputting the source data, more preferably within 36 hours, and even more preferably within 24 hours.

### Examples

The customer sent the print data to Honeywell Advanced Circuits using the RS274x standard. Other data such as certain customer specifications were sent via hard copy.

Preproduction Engineering transferred customer specs to various electronic systems, including the AS400 system so electronic and hard copies of the process and materials required at the lamination and other processes are available. The components in a preferred final laminated panel are detailed in Table 1 and were in the physical relationship as described in FIG. 4. Additionally, the following components enter the lamination process as a single sheet of material: 420-425-430, 440-425-450, 460-425-470, 475-425-480, and 485-425-490. In each case, the copper components of the materials (e.g., copper layers 420 and 430 in the sheet 420-425-430), are etched such that the image is that specified by the customer. Hereafter, the entire set of components in FIG. 4 and detailed in Table 1 less copper 410 will be referred to as 499.

The Lamination Department conducted a kappa study to determine if our measurement system (visual inspection) of classifying panels as embossed or not embossed is an acceptable system. (e.g., if a panel is embossed will two different operators identify the panel as embossed when they visually inspect it). In general a kappa value of 0.7 is interpreted as indicating that the measurement system is acceptable. The study resulted in a kappa value of 0.742. Thus the measurement system of visual inspection of the panels is considered acceptable.

Next, the Lamination Department conducted a design of experiment (DOE) to optimize the lamination process for the reduction or elimination of embossing on panels while maintaining external surface quality. The DOE was a two level full factorial design. The factors were heat rise (8° F./minute versus 11° /minute) and lamination lay up design 10 (a sheet of copper-aluminum-copper versus a sheet of copper-aluminum 30-50 stainless steel 20 aluminum-copper 50-40). The DOE consisted of eight panels for each of the four run recipes (e.g., 8° F./minute and copper-aluminum-copper, 11° F./minute and copper-aluminum-copper, etc.). Two individuals visually inspected each panel three times each. Specifically, individual #1 randomly inspected all 32 panels once. Individual #2 then randomly inspected all 32 panels once. This process was repeated until both individuals inspected the panels three times each. For each inspection, an embossed panel was assigned an inspection value of −1 and non-embossed panel was assigned an inspection value of +1. After each individual inspected all panels three times, each panel was assigned a value equal to the sum of the inspection values from the six inspections of that panel. For example, if the inspection values for a given panel had been −1, −1, −1, −1, −1 and 1 then the panel value would have been −4. Additionally, each run recipe was assigned a run value equal to the average of the panel values from the eight panels associated with the run recipe. For example, if the panel values of the panels associated with the 8° F./minute and copper-aluminum-copper run recipe had been −4, −4, −4, −4, −4 and −2 then the run value would have been −3.75.

Analysis of the DOE included a half normal plot, a pareto chart of the effects, an effect graph, and a fully nested analysis of variance. Each analysis indicated that the lamination lay up design was a significant factor in the measured response (embossing). The fully nested analysis of variance also indicated that the results were statistically significant.

Based on the results data set obtained from Preproduction Engineering, the kappa study, DOE and other standard operating procedures generally used in the lamination process, the operating conditions were obtained. FIGS. 5 and 6 display the physical relationship of the components used within a lamination press fixtures or books. The press used contained eight books. Within each book all components are laid up using pins and fixture bushings. The entire package is then fastened to the fixture 610 via the pin system. A coat of mold release is applied to all stainless steel materials including the fixture 610, pin, fixture bushings and stainless steel 510 and 620. Table 2 provides detailed information on the components used. Hereafter, the entire set of layers as described in FIG. 5 and Table 2 will be referred to as 599. FIG. 6 illustrates an entire lay-up with multiple sets of layers 599. As will be understood, the arrangement of FIG. 6 will cause an entire separator sheet of the present invention to be formed, i.e. 530-520-510-520-530.

The lamination press cycle is given in Table 3. The heat rise during the cycle was 11° F./minute and the parameters for the cool press after lamination is 45 minutes with a cool down of 6° to 8° F./minute. The temperature at the end of the cool down cycle ranges from 80° F. to 100° F.

Finally, the standard operating procedures in the Lamination Department were changed to process this product as described above. Affected items include written work instructions in both memo and training manual formats, computer databases including the AS400, and preproduction engineering data. Over time other product has been converted to this type of process.

Under the revised procedures, when the components are laid up at the lamination process the separator sheet components (copper-aluminum 520-530 and stainless steel 510 and 630) are placed in relation to the other components as detailed in FIGS. 5 and 6.

During the lamination process the copper components the separator sheet 530 become part of the electronic component (i.e., the laminated panel). After the lamination process is completed the aluminum 520 and stainless steel 510 and 630 components of the separator sheet are removed and do not become part of the electronic component.

Table 4 contains some alternate materials that could be used in place of those used in the example given.

Thus, specific embodiments and applications of electronic components comprising production and incorporation of separator sheets that can minimize or eliminate embossing defects have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

TABLE 1

| | | Nominal | Nominal | Nominal | |
|---|---|---|---|---|---|
| | | thickness | Width of | length of | |
| | | of material | material at | material at | |
| | | at the start | the start | the start | |
| | | of the | of the | of the | |
| | | lamination | lamination | lamination | |
| Number in | | process | process | process | |
| | Material | (inches) | (inches) | (inches) | Notes |
| 410 | Copper | 0.0007 | 20.0 | 26.0 | |
| 415 | FR4 | 0.0072 | 18.5 | 24.5 | Material must meet the |
| | | | | | requirements of Mil Std |
| | | | | | 13949 and RPP596. |
| 417 | FR4 | 0.0062 | 18.5 | 24.5 | Material must meet the |
| | | | | | requirements of Mil Std |
| | | | | | 13949 and RPP596. |
| 420 | Copper | 0.0014 | 18.5 | 24.5 | |
| 425 | FR4 | 0.00073 | 18.5 | 24.5 | Material must meet the |
| | | | | | requirements of Mil Std |
| | | | | | 13949, RPP621, and |
| | | | | | RPP5963. Edges and |
| | | | | | tooling holes must be |
| | | | | | free of burrs. |
| 430 | Copper | 0.0014 | 18.5 | 24.5 | |
| 440 | Copper | 0.0014 | 18.5 | 24.5 | |
| 450 | Copper | 0.0014 | 18.5 | 24.5 | |
| 460 | Copper | 0.0014 | 18.5 | 24.5 | |
| 470 | Copper | 0.0014 | 18.5 | 24.5 | |
| 475 | Copper | 0.0014 | 18.5 | 24.5 | |
| 480 | Copper | 0.0014 | 18.5 | 24.5 | |
| 485 | Copper | 0.0014 | 18.5 | 24.5 | |
| 490 | Copper | 0.0014 | 18.5 | 24.5 | |

TABLE 2

| Number in | | Nominal | Nominal | Nominal | |
|---|---|---|---|---|---|
| FIGS. 5 or | | Thickness | Width | Length | |
| 6 | Material | (inches) | (inches) | (inches) | Notes |
| 510 and 630 | Stainless steel | 0.040 +/− 0.004 | 20.5 | 26.5 | 630 Stainless steel; |
| | | | | | hardness = 45-50 RC; |
| | | | | | flatness = 0.60″/ft tir; |
| | | | | | Surface finish = 12 rms; |
| | | | | | parallelism = 0.001″ tir; |
| | | | | | all edges deburred and |
| | | | | | rounded |
| 520 | Aluminum | 0.015 | 20.0 | 26.0 | |
| 530 | Copper | 0.0007 | 20.0 | 26.0 | |
| 610 | Fixture | 0.050 | 24.5 | 29.5 | |
| 620 | Paper leveling | 0.050 | 24.5 | 29.5 | |
| | pad | | | | |

TABLE 3

| Set pressure (PSI) | Set Temperature (F.) | Hold time (minutes) |
|---|---|---|
| 25 | 335 | 5 |
| 150 | 355 | 7 |
| 150 | 370 | 10 |
| 150 | 380 | 5 |
| 150 | 400 | 27 |
| 150 | 365 | 20 |
| 75 | 180 | 10 |
| 75 | 175 | 10 |

TABLE 4

| Copper 530 could | Aluminum 520 could be | Stainless steel 510 and 630 |
|---|---|---|
| be replaced with | replaced with | could be replaced with |
| Aluminum | Stainless steel (bonded | Multiple sheets of |
| | to the component 530) | stainless steel |
| | Copper (bonded to the | |
| | component 530) | |

What is claimed is:

1. A separator sheet for use in manufacturing an electronic component, comprising:
an alloy substrate layer having a top surface and a bottom surface;
a first metal layer;
a second metal layer;
a first intermediate metallic material that couples the first metal layer to the top surface of the substrate layer; and
a second intermediate metallic material that couples the second metal layer to the bottom surface of the substrate layer.

2. The separator sheet of claim 1, wherein the electronic component comprises a circuit board.

3. The separator sheet of claim 1, wherein the alloy substrate layer comprises a steel-based compound.

4. The separator sheet of claim 3, wherein the steel-based compound comprises stainless steel.

5. The separator sheet of claim 1, wherein the top surface and the bottom surface are substantially smooth and free of physical defects.

6. The separator sheet of claim 1, wherein the first and second metal layers are laminating materials.

7. The separator sheet of claim 1, wherein the first metal layer and the second metal layer comprise the same material.

8. The separator sheet of claim 1, wherein the first and second metal layers are copper or nickel.

9. The separator sheet of claim 1, wherein the first intermediate metallic material and the second intermediate metallic material comprise a same material.

10. The separator sheet of claim 9 wherein the same material is aluminum.

11. The separator sheet of claim 9, wherein the intermediate metallic material further comprises an adhesive compound.

12. A method of producing a separator sheet comprising:
providing an alloy substrate layer, wherein the layer comprises a top surface and a bottom surface;
providing a first metal layer coupled to an first intermediate metallic layer to form a first pair;
providing a second metal layer coupled to a second intermediate metallic layer to form a second pair; and
coupling the first pair to the top surface of the alloy substrate layer
coupling the second pair to the bottom surface of the alloy substrate layer.

13. A method of producing an electronic component comprising:
preparing a separator sheet according to claim 12;
providing a substrate;
coupling at least one of the separator sheet to the substrate; and
coupling at least one of an additional layer to the at least one of the separator sheet.

14. The method of claim 13, wherein the substrate is a silicon wafer.

15. The method of claim 16, wherein the additional layer is a laminate material.
